(19) United States
(12) Patent Application Publication
(10) Pub. No.: US 2025/0245108 A1
(43) Pub. Date: Jul. 31, 2025

(54) SYSTEMS AND METHODS FOR PROVIDING NEAR ZERO DOWNTIME DURING DATABASE UPGRADES

(71) Applicant: Verizon Patent and Licensing Inc., Basking Ridge, NJ (US)

(72) Inventors: Randolph Torres, Merritt Island, FL (US); Antra Malhotra, Tampa, FL (US); Corbin P Moline, Merritt Island, FL (US); Michael T Bayne, Wesley Chapel, FL (US)

(21) Appl. No.: 18/425,043

(22) Filed: Jan. 29, 2024

(51) Int. Cl. G06F 11/20; G06F 16/23

(52) U.S. Cl. CPC G06F 11/203; G06F 16/2379

(57) ABSTRACT

One or more computing devices, systems, and/or methods for providing near zero downtime during database upgrades for a computing environment are provided. A first database instance of a first version of a database may be hosted within a computing environment. A second database instance of a second version of the database may be deployed within the computing environment. The database instances are configured with triggers used to propagate data changes amongst the database instances. Requests to the database are routed based on a plurality of routing rules. A first routing rule routes a first portion of the requests to the first database instance and a second portion of the requests to the second database instance. The second database instance is monitored to determine whether to progress to a second routing rule of the plurality of routing rules.

### BACKGROUND

An application may use data that is stored in databases maintained within a cloud computing environment. Certain applications may read data from a database, while other applications may write data to the database. When the database and/or an application that utilizes the database is being upgraded, the existing database and application are taken offline, resulting in downtime for clients that utilize the application. Once an upgraded version of the database and/or application are deployed within the cloud computing environment, the clients are provided with access to the upgraded database and application.

### BRIEF DESCRIPTION OF THE DRAWINGS

While the techniques presented herein may be embodied in alternative forms, the particular embodiments illustrated in the drawings are only a few examples that are supplemental of the description provided herein. These embodiments are not to be interpreted in a limiting manner, such as limiting the claims appended hereto.

FIG. 1 illustrates an example of a system for providing near zero downtime for database usage by applications, in accordance with an embodiment of the present technology;

FIG. 2 is a flow chart illustrating an example method for providing near zero downtime for database usage by applications, in accordance with an embodiment of the present technology;

FIGS. 3A-3E illustrate an example of a system for providing near zero downtime for database usage by applications, in accordance with an embodiment of the present technology;

FIG. 4 is a flow chart illustrating an example method for providing near zero downtime for database usage by applications utilizing database schemas within a distributed database, in accordance with an embodiment of the present technology;

FIG. 5A illustrates an example of a system for providing near zero downtime for database usage by applications utilizing database schemas within a distributed database, in accordance with an embodiment of the present technology;

FIG. 5B illustrates an example of a system for providing near zero downtime for database usage by applications utilizing active and standby clusters within regions, in accordance with an embodiment of the present technology;

FIG. 6 is an illustration of example networks that may utilize and/or implement at least a portion of the techniques presented herein;

FIG. 7 is an illustration of a scenario involving an example configuration of a computer that may utilize and/or implement at least a portion of the techniques presented herein;

FIG. 8 is an illustration of a scenario involving an example configuration of a client that may utilize and/or implement at least a portion of the techniques presented herein;

FIG. 9 is an illustration of a scenario featuring an example non-transitory machine readable medium in accordance with one or more of the provisions set forth herein.

### DETAILED DESCRIPTION OF EXAMPLE EMBODIMENTS

Subject matter will now be described more fully hereinafter with reference to the accompanying drawings, which form a part hereof, and which show, by way of illustration, specific example embodiments. This description is not intended as an extensive or detailed discussion of known concepts. Details that are well known may have been omitted, or may be handled in summary fashion.

The following subject matter may be embodied in a variety of different forms, such as methods, devices, components, and/or systems. Accordingly, this subject matter is not intended to be construed as limited to any example embodiments set forth herein. Rather, example embodiments are provided merely to be illustrative. Such embodiments may, for example, take the form of hardware, software, firmware or any combination thereof. The following provides a discussion of some types of computing scenarios in which the disclosed subject matter may be utilized and/or implemented.

One or more systems and/or techniques for providing near zero downtime for database usage by applications are provided. A client may access an application that stores data within a database. The application may be hosted within a computing environment such as a cloud computing environment. The application may provide functionality (e.g., video streaming functionality, computing environment management functionality, network management functionality, data storage functionality, email functionality, etc.) to various types of clients such as user equipment, servers, a television, a smart device, a laptop, and/or other types of clients. The computing environment may host storage such as databases that store data used by applications for operation. An application may perform create operations, read operations, update operations, and/or delete operations against a database. In some embodiments, the application is hosted within a cloud computing environment such as through a Kubernetes pod or container. A wide variety of applications may utilize the databases within the computing environment, such as a network management application, video game application, a social network application, a multi-media application, an email application, etc.

Over time, new versions of the applications and databases may become available for deployment within the computing environment. Conventional upgrade techniques take an application and database offline during upgrade. While the application and a database are offline, clients are no longer able to utilize the application, which can result in unacceptable downtime for clients that expect applications to be always available. As part of the upgrade, a new version of the database and/or the application may be deployed to the computing environment. During deployment, clients are still experiencing downtime and unavailability where the clients cannot access the offline application and database. Furthermore, the upgraded application and/or database are not yet available for access until the upgrade and deployment process is completely finished. Once the upgraded application and/or database are deployed, then testing may be performed before the upgraded application and database are made available to clients. The overall upgrade, deployment, and testing processing results in unacceptable downtime for clients that affect the functionality and performance of user equipment, which is further exacerbated if there is a failure and rollback during the process.

The disclosed techniques overcome these technical challenges related to client downtime and unavailability during database upgrades or during normal operation of a database by providing zero or near zero downtime for clients that access applications storing data within the database. In some embodiments, a progressive rollout of the upgrade is performed so that some requests are routed to the old version of the database and some requests are routed to the new version of the database. As requests are successfully processed through the new version of the database, a larger percentage of the requests are routed from the old version of the database to the new version of the database. Modifications to the different versions of the databases are synchronized so that the modifications are made to both versions of the database. In some embodiments, the different versions of the database are modified with triggers used to propagate changes between the different versions of the database in order to keep the database versions in-sync.

In some embodiments, the old version of the database is hosted within a first region within the computing environment (e.g., an eastern region, a particular city, a particular data center, a particular server, a geographical region, etc.) and the new version of the database is hosted within a second region within the computing environment. In some embodiments, redundant copies of the old version and the new version of the databases are maintained within different regions for redundancy, failover, and disaster recovery during the progressive rollout of the upgrade. In some embodiments, a single distributed database is used with a first schema corresponding to the old version of the database and a second schema corresponding to the new version of the database.

In response to the new version of the database successfully operating over a time period, the old version of the database is removed and all requests are routed to the new version of the database to complete the upgrade. In order to reduce or eliminate any client experienced downtime during the upgrade process, requests can be rerouted from the new version of the database to the old version of the database in the event of a failure or other error condition occurring. In particular, if one or more requests are unsuccessfully processed using the new version of the database (e.g., a certain threshold number of failed requests within a certain timespan), then either some or all requests are rerouted from the new version of the database to the old version of the database. In some embodiments, the new version of the database is still maintained in an operational state to process a smaller portion/percentage of the requests. In some embodiments, the new version of the database is paused while all requests are routed to the old version of the database. In some embodiments, a remedial action (corrective action) is performed to fix the issue with the new version of the database (e.g., the new version of the database may be updated/modified and/or redeployed in order to resolve the issue). In this way, client downtime is reduced or eliminated because requests can be rerouted back to the old version of the database if an issue occurs.

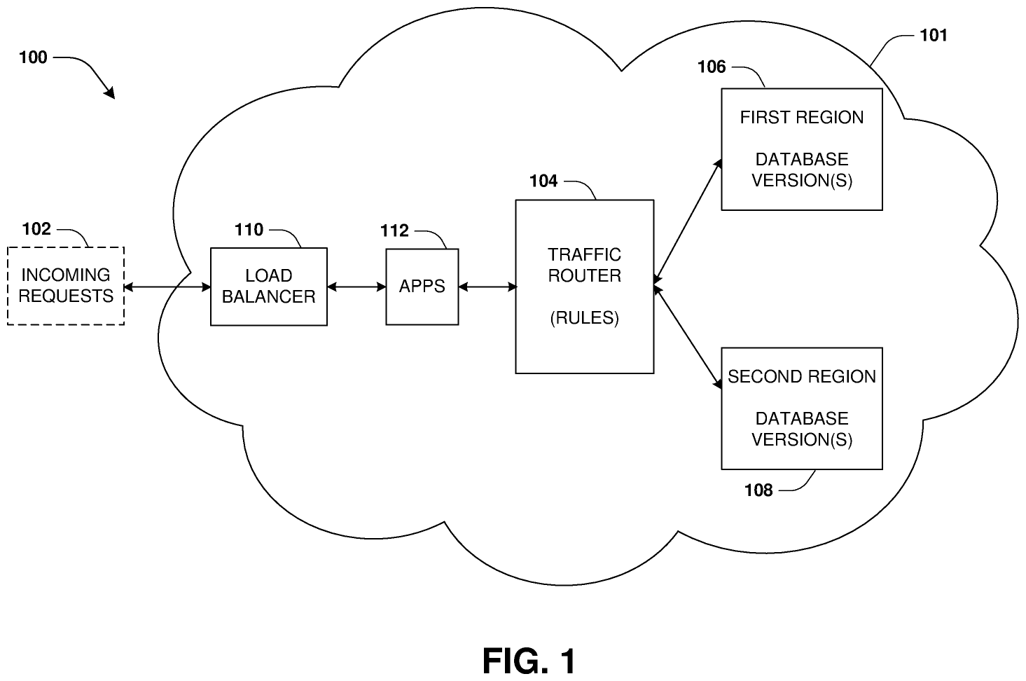

FIG. 1 illustrates an example of a system 100 for providing near zero downtime for applications accessing a database within a computing environment 101 (e.g., a cloud environment composed of multiple datacenters in different regions where applications connect to a database hosted within the cloud environment). Applications 112 may be hosted within the computing environment 101 (e.g., hosted on network equipment such as a server of the computing environment 101) and/or external to the computing environment 101 (e.g., hosted on user equipment such as a desktop application on a laptop or an app installed on a cellular phone; hosted by a third-party platform such as a public cloud platform, a private cloud platform, a social network platform; etc.). The applications 112 may utilize data stored within the database hosted within the computing environment 101 for operation. The applications 112 may perform requests that require database operations such as create, read, update, and delete operations. In some embodiments, incoming requests 102 to applications 112 are received by a load balancer 110. The load balancer 110 may distribute (load balance) the incoming requests 102 amongst the applications 112. The applications 112 may process the incoming requests 102 by accessing databases through a traffic router 104. Traffic router 104 (as further described below) provides a layer between an application and a database that implements request routing processing. It may be appreciated that the computing environment 101 may implement the traffic router 104 as multiple instances of traffic routers 104 that may be duplicated and distributed over the computing environment, such as a traffic router per region of the computing environment 101 (e.g., an eastern region, a western region, or any other geographical region), which may be useful for redundancy/failure recovery and/or load balancing.

The first database instance of a first version of the database (e.g., a current version of the database that is being utilized by the applications 112) may be hosted within one or more regions of the computing environment 101, such as a first region 106, a second region 108, and/or other regions within the computing environment 101. In some embodiments, merely a single instance of the first version of the database is hosted within the computing environment 101 such as the first region 106. In some embodiments, multiple instances of the first version of the database are hosted within the computing environment 101 such as the first region 106 and also the second region 108 for redundancy, failover, and disaster recovery purposes.

An upgrade for the database and/or the applications 112 that utilize the database may be performed according to a progressive rollout upgrade scheme. The database may be upgraded to a second version of the database. While the first database instance of the first version of the database (or multiple instances of the first version of the database) is hosted within the computing environment 101, a second database instance of the second version (or multiple instances of the second version of the database) may also be deployed within the computing environment 101. In some embodiments, the first database instance and the second database instance are hosted within different regions of the computing environment 101, which may be useful for progressive rollout (described below).

Modifications made to the data stored in first database instance or the second database instance are synchronized between the database instances (e.g., synchronization of insert, delete, update, and/or other operations performed by the applications 112) utilizing triggers configured for the database instances. In this way, the traffic router 104 can route database operations from the applications 112 to either the first database instance of the first version of the database or the second database instance of the second version of the database, and the request will access the same data.

The traffic router 104 implements progressive rollout rules to determine how to route the database operations (e.g., database operations from the applications 112 that are processing the incoming requests 102) to either the first database instance of the first version of the database (e.g., the current/old version) or the second database instance of the second version of the database (e.g., an upgraded/new version). Initially, a first portion of the database operations from the applications 112 may be routed to the first database instance of the first version of the database and a second portion of the database operations may be routed to the second database instance of the second version of the database. Based upon successful operation of the second database instance (e.g., a certain threshold number of database operations being successfully processed by the second database instance over a timespan, a certain time period over which there is a threshold percentage of successfully processed database operations by the second database instance (such as a 98% success rate over a 10-minute timespan), etc.), a greater portion of the database operations are routed to the second database instance. Once a certain portion of the database operations are being routed to and successfully processed by the second database instance of the second version of the database, the first database instance of the first version of the database may be taken offline and all of the database operations are routed to the second database instance of the second version of the database to complete the upgrade.

If a failure or other error condition arises during the upgrade, then various remedial actions may be performed to provide clients with near zero downtime. If a certain percentage of database operations are unsuccessfully processed through the second database instance of the second version of the database, then the traffic router may either cause all database operations to be routed to the first database instance or reduce the portion of the database operations routed to the second database instance of the second version of the database. A remedial action (corrective action) may be performed to address the failure or other error condition, such as where the second database instance of the second version of the database is modified (e.g., code, functions, methods, structures, and/or data of the second database instance may be modified/updated to fix the failure or issue; the second database instance may be redeployed; etc.). The traffic router may be instructed to resume (or restart) the progressive rollout process once the second database instance once the remedial action is complete.

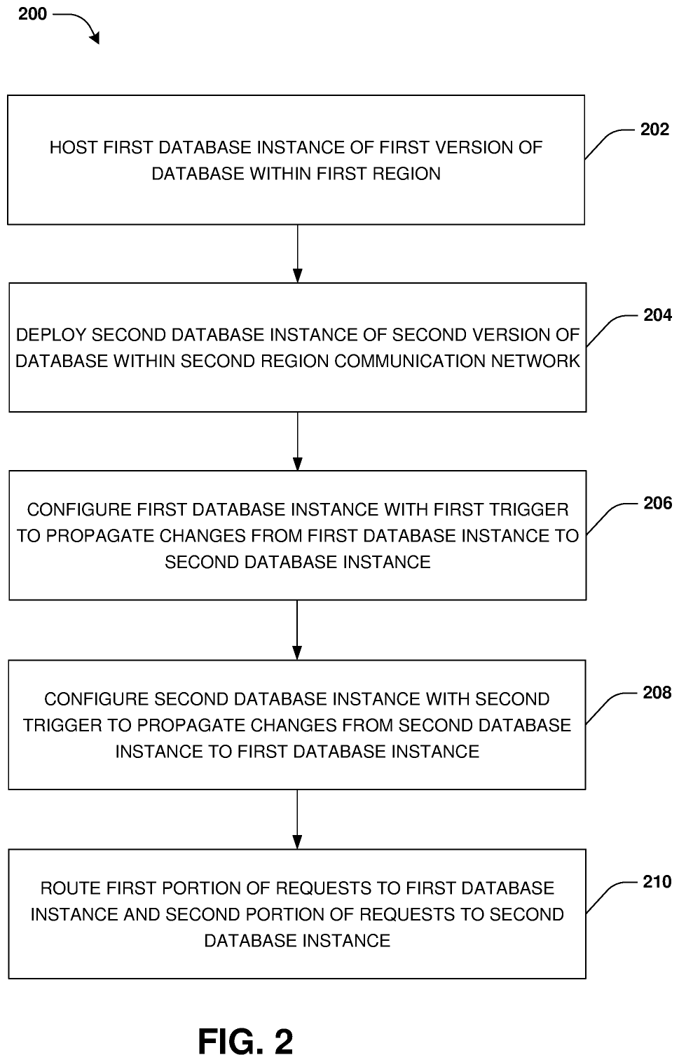

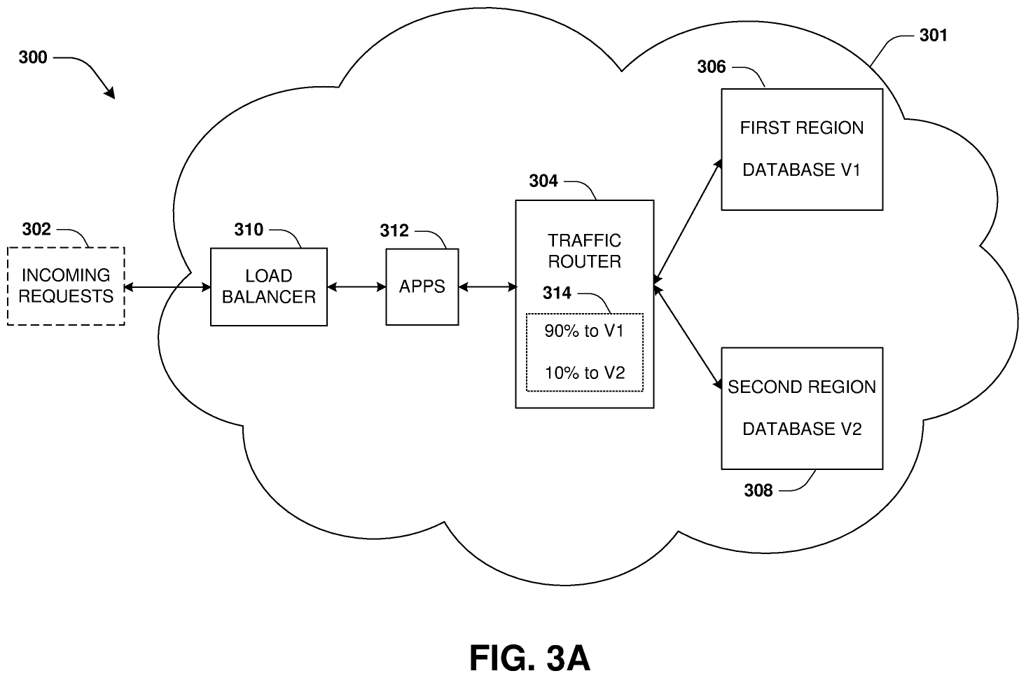

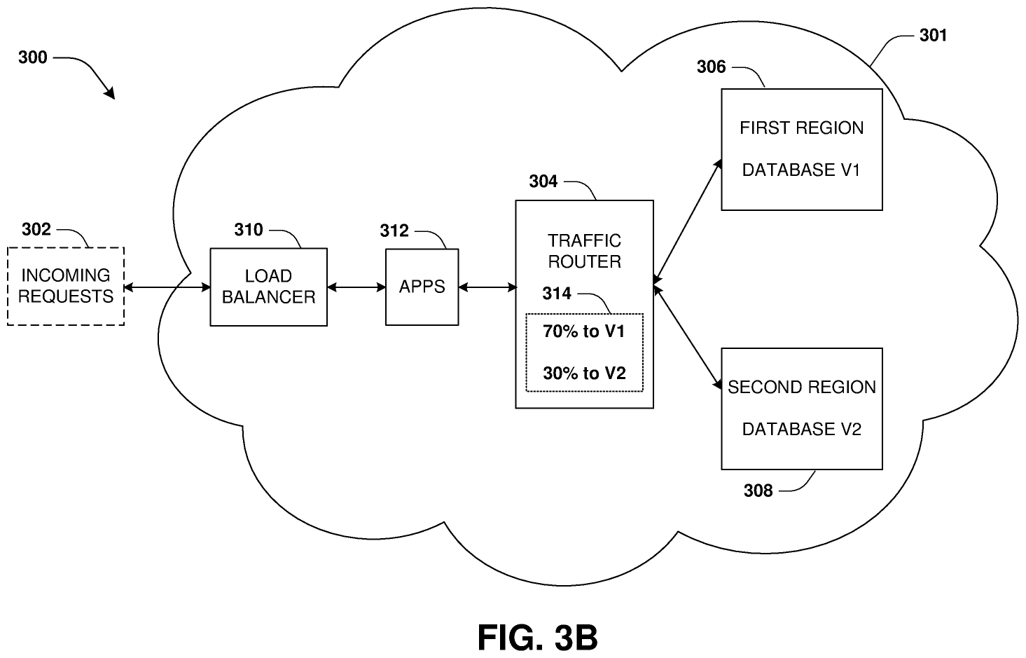

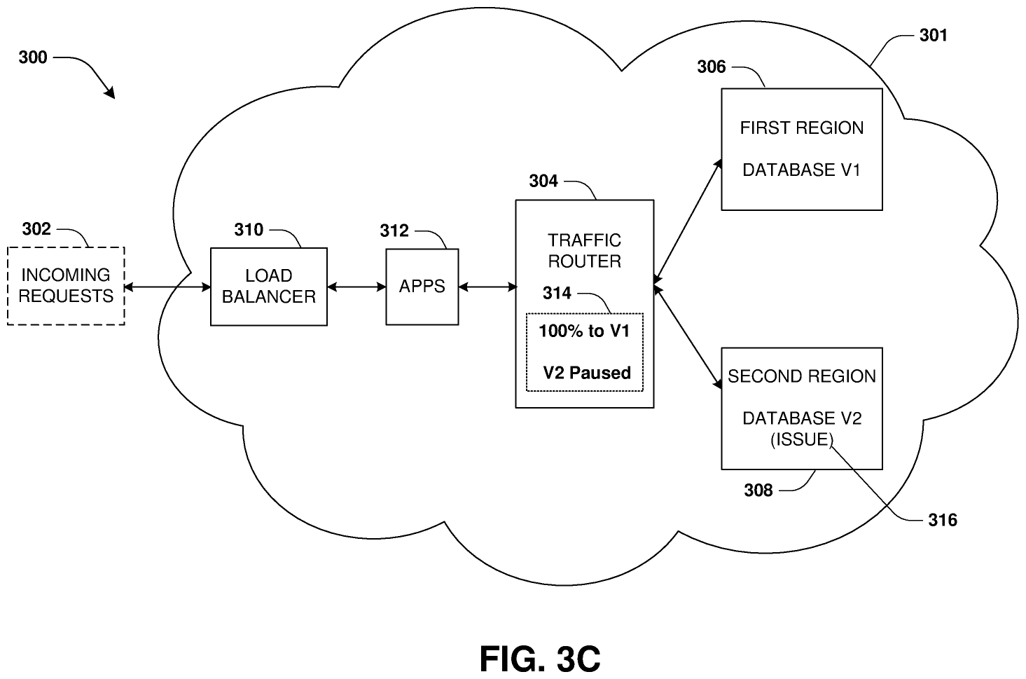

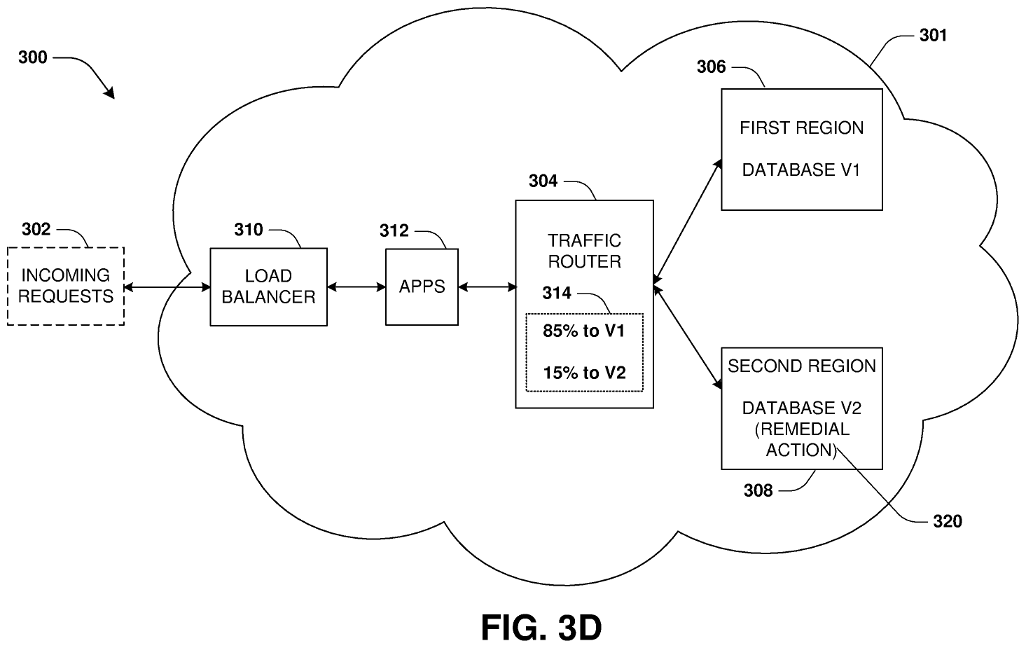

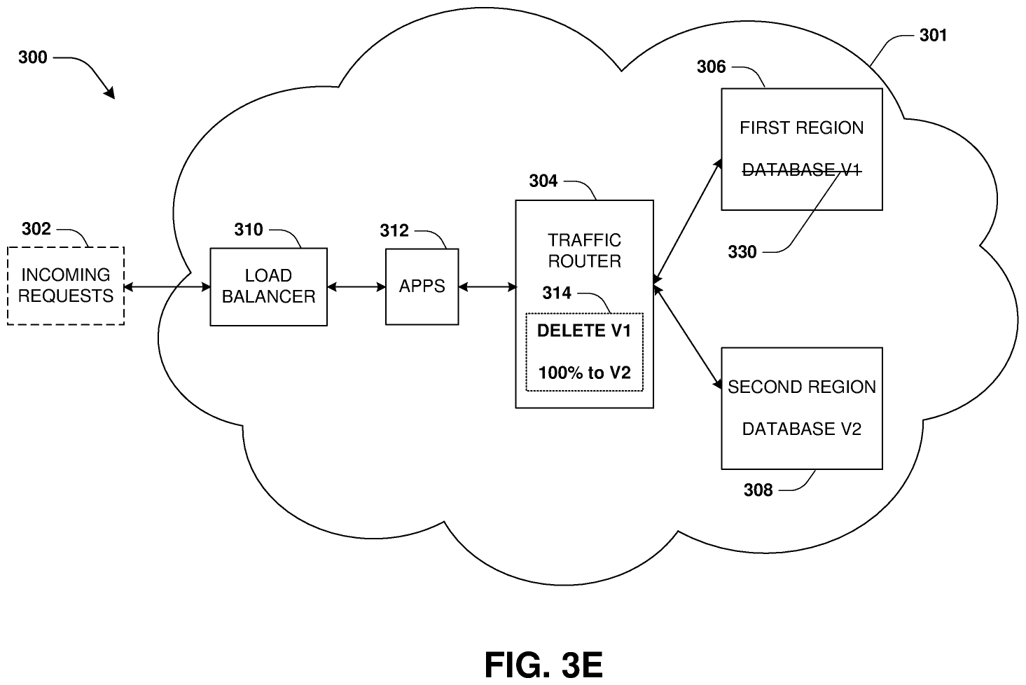

FIG. 2 is a flow chart illustrating an example method 200 for providing near zero downtime during database upgrades, which is further described in conjunction with system 300 of FIGS. 3A-3E. In the example of FIGS. 3A-3E, the databases and applications are part of a computing environment 301 which provides user equipment with communication capabilities using the computing environment 301 (such as a cloud computing infrastructure for a cellular network). Applications 312 may be hosted within the computing environment 301 (e.g., hosted on network equipment) or external to the computing environment 301 (e.g., hosted on user equipment; hosted by a third-party platform; etc.). The applications 312 may utilize data stored within a database hosted within the computing environment 301. The applications 312 may perform database operations such as create, read, update, and delete operations. In some embodiments, incoming requests 302 are received by a load balancer 310. The load balancer 310 may distribute (load balance) the incoming requests amongst the applications 312. Computing environment 301 may be arranged into regions (e.g., on a logical and/or geographic basis), such that the computing environment 301 includes a first region 306 and a second region 308.

The applications 312 may process the incoming requests 302 by accessing databases through a traffic router 304, which provides a layer between an application and a database. It may be appreciated that the computing environment 301 may include any number of traffic router instances such as a traffic router per region of the computing environment 301.

A database used by the applications may need to be upgraded. For example, the database may need to have columns and/or tables added to accommodate new data collection, or the semantics and/or format of a data column may need to be changed. As one example, a new network element may be added to a network whose performance monitoring data is stored in the database. A new table may need to be added to accommodate the new element, and new columns may need to be added to existing tables to allow data storage from this new element. As another example, the data size of a column may need to be adjusted due to a change in the type of data being collected. These upgrades will be performed to create a second version of the database.

During operation 202 of method 200, the first database instance of a first version of the database (e.g., a current version of the database that is being currently utilized by the applications 312 and/or user equipment) may be hosted within the first region 306 within the computing environment 301. In some embodiments, one or more duplicate instances of the first version of the database may be maintained within other regions of the computing environment for redundancy and failover (e.g., high availability) purposes in the event the first database instance of the first version of the database becomes unavailable (e.g., due to a failure within the first region 306).

During operation 204 of method 200, a second database instance of a second version of the database (e.g., an upgraded version) is deployed within the second region 308 of the computing environment 301. In some embodiments, one or more duplicate instance of the second version of the database may be deployed within other regions of the computing environment for redundancy and failover (e.g., high availability) purposes in the event second database instance of the second version of the database becomes unavailable (e.g., due to a failure within the second region 308). The second version of the database may relate to an upgraded version of the database that is to be deployed utilizing the disclosed progressive rollout technique.

During operation 206 of method 200, the first database instance of the first version of the database is configured with a first trigger (or any number of triggers). The first trigger comprises a condition that when met, causes the first trigger to propagate data changes/modifications from the first database instance of the first version of the database to the second database instance of the second version of the database. The condition may relate to one of the applications 312 performing a create, update, or delete database operation upon the first database instance of the first version of the database, which is then propagated by the first trigger to the second database instance of the second version of the database (and to any other duplicate instances of the second version of the database and/or other duplicate instances of the first version of the database) in order to synchronize the first and second database instances. The trigger may be configured to handle the changes made to create the second database. For example, the trigger may avoid updating columns/tables that have been dropped, map columns/tables from the first database to different columns/tables in the second database, perform data transformation on data for columns that have had their semantics or format changed, etc.

During operation 208 of method 200, the second database instance of the second version of the database is configured with a second trigger (or any number of triggers). The second trigger comprises a condition that when met, causes the second trigger to propagate data changes/modifications from the second database instance of the second version of the database to the first database instance of the first version of the database. The condition may relate to one of the applications 312 performing a create, update, or delete database operation upon the second database instance of the second version of the database, which is then propagated by the second trigger to the first database instance of the first version of the database (and to any other duplicate instances of the first version of the database and/or other duplicate instances of the second version of the database) in order to synchronize the first and second database instances. The trigger may be configured to handle the changes made to create the second database. For example, the trigger may avoid updating columns/tables that have been dropped, map columns/tables from the second database to different columns/tables in the first database, perform data transformation on data for columns that have had their semantics or format changed, etc.

During operation 210 of method 200, the traffic router 304 utilizes progressive rollout rules 314 to determine how to route the database operations, corresponding to incoming requests 302 being processed by the applications 312, amongst database instances of the first version and the second version of the database, as illustrated by FIG. 3A. Based upon the progressive rollout rules 314, the traffic router 304 routes a first portion of the database operations to the first database instance of the first version of the database. The traffic router 304 routes a second portion of the database operations to the second database instance of the second version of the database.

In some embodiments, the progressive rollout rules 314 may be based on (solely or partially) specifying a percentage of requests that should be routed to the first version and second version of the database. For example, as shown in FIG. 3A, an initial rule may specify that 10% of the requests received be routed to the second version of the database while the remaining 90% of requests are routed to the first version of the database. If the second database is determined to be operating successfully, as shown in FIG. 3B, a second rule may specify that 30% of the requests be routed to the first version of the database and the remaining 70% of the requests be routed to the first version of the database. As the second database continues to perform successfully, progressively more requests may be routed to the second database by percentage, until all requests are routed to the second version of the database.

In some embodiments of utilizing the progressive rollout rules 314, the routing rules may be based on (solely or partially) specifying a user and/or region associated with the request, such as where requests from a first region or first group of users are routed to the second version of the database while other requests are routed to the second version of the database. As the second database is determined to be operating successfully, routing rules for additional users/regions may be added to increase the usage of the second version of the database. In some embodiments progressive rollout rules 314 may be based one (solely or partially) specifying performance levels (e.g., number of requests per hour) and/or date/time windows (e.g., weekdays during business hours), which can be useful to avoid (or test responsiveness to) high-stress utilization. For example, routing rules may specify the second database is sent requests during off-hours or limited to low usage rates, while the first database is sent requests during busy hours or with no usage limit. In some embodiments, progressive rollout rules 314 may be based on (solely or partially) specifying a request type, which may reflect the volume, complexity or frequency of such requests. For example, the rules may have only read based traffic (e.g., SELECT only operations) be directed to the second version of the database while all other request types may be directed to the first version of the database.

The progressive rollout rules 314 may use a combination of any or all of these potential rules, and may be configurable based upon the characteristics of the database, the applications that use it, and/or the changes/versioning being performed.

Processing the database operations by the second database instance of the second version of the database may be monitored (e.g., by the traffic router 304; an artificial intelligence monitoring tool; or other network equipment or component of the computing environment 301) to track whether the database operations are being successfully or unsuccessfully processed. In some embodiments, monitoring may be implemented as part of the traffic router 304, which can monitor requests that have been routed to the databases and the responses made by the databases to those requests in order to detect failure conditions and derive request results metrics (e.g., response latency, throughput levels, error rates). Monitoring can include periodically using probe/test requests to measure/discover performance issues (e.g., deadlock detection) The monitoring can also include operational monitoring of the database instances for database performance metrics (e.g., memory usage, transaction statistics) and platform performance metrics (e.g., CPU utilization, RAM utilization, IO utilization).

Monitoring rules may be used to make determinations as to whether a database instance is performing normally. In some instances monitoring rules may apply the metrics from monitoring operations to thresholds in order to determine whether a database instance is operating successfully. Potential rules may be based on service level agreements for query performance (e.g., maximum CRUD query latency, minimum query throughput), maximum levels of invalid results (e.g., query failure rates) and/or maximum levels of resource usage (e.g., CPU/Memory/IO utilizations over 80%).

In some embodiments, a machine learning system may be used to detect deviations from normal operation. For example, the system may monitor the throughput rate during normal operation of the first database instance, and compare this to the throughput rate of the second database instance to determine if the operation is within expectations.

In some embodiments, the monitoring of the database operations being processed the second database instance of the second version of the database may indicate an issue 316 (e.g., a failure), as illustrated by FIG. 3C. The issue 316 may be detected through one of the monitoring rules discussed above. A result of detecting the issue may be to determine a corrective action to execute. The corrective action may be to dynamically modify the progressive rollout rules 314 so that the traffic router 304 routes the database requests differently. In some embodiments, the progressive rollout rules 314 may be modified/overridden by the corrective action to pause the traffic router 304 from routing the database requests to the second database instance of the second version of the database and to route all requests to the first database instance of the first version of the database, as illustrated by FIG. 3C. In some embodiments, a reduced portion of the database requests (e.g., a subset of the current second portion of the database operations) are routed to the second database instance of the second version of the database, instead of completely pausing the routing of database requests to the second database instance.

In some embodiments, as part of performing the corrective action, a remedial action 320 may be performed to correct the issue 316, as illustrated by FIG. 3D. In some embodiments, the remedial action 320 may be determined by the traffic router 304 and instructed through an API to a database instance to perform the remedial action to the database. In some embodiments, the remedial action 320 may be instructed through a cloud platform API to redeploy the second database instance of the second version of the database in order to recover from a failure, potentially with environmental modifications (e.g., adding additional computing resources, additional instances). In some embodiments, the remedial action will include notifying a system administration platform that can raise an alarm. The notification may include information related to the issue (e.g., the monitoring rule that triggered the failure detection, the relevant metrics that triggered the rule). The monitoring operation may detect a successful completion of the remedial action 320, and the progressive rollout rules 314 may be restarted to permit request routing to the second database instance. In some embodiments, the progressive rollout rules 314 may not be restarted from an initial routing rule, but may be restarted from an intermediate routing rule, such as a routing rule that provides for routing at a service level at or below the level at which the error condition was detected. For example, if a failure was detected during use of a routing rule that routed 20% of the requests to the second version of the database, the routing rules be restarted use a routing rule that routes 15% of the requests to the second version of the database, instead of the initial rule that routed 10% of the requests to the second version of the database.

The monitoring may detect that the second database instance of the second version of the database has been successfully operating over a particular timespan (e.g., successfully processing 95% of all database operations received by the traffic router 304). Accordingly, the traffic router 304 may complete the progressive rollout rules by routing all requests to the second database version. The first database instance of the first version of the database may be removed 330, as illustrated by FIG. 3E. In this way, the upgrade may be designated as being successfully completed.

The example implementation of the near zero down time upgrade system and method is effective to avoid overall system unavailability due to database upgrade issues. As an example, an update to a column may be misconfigured to not be capable of storing data of the type expected. In such a case, the upgraded database may cause request failures that are detected by the traffic router, which will reroute requests to instances of the existing version of the database. The error conditions that caused the failure can be assessed and the database corrected without the application being noticeably impacted

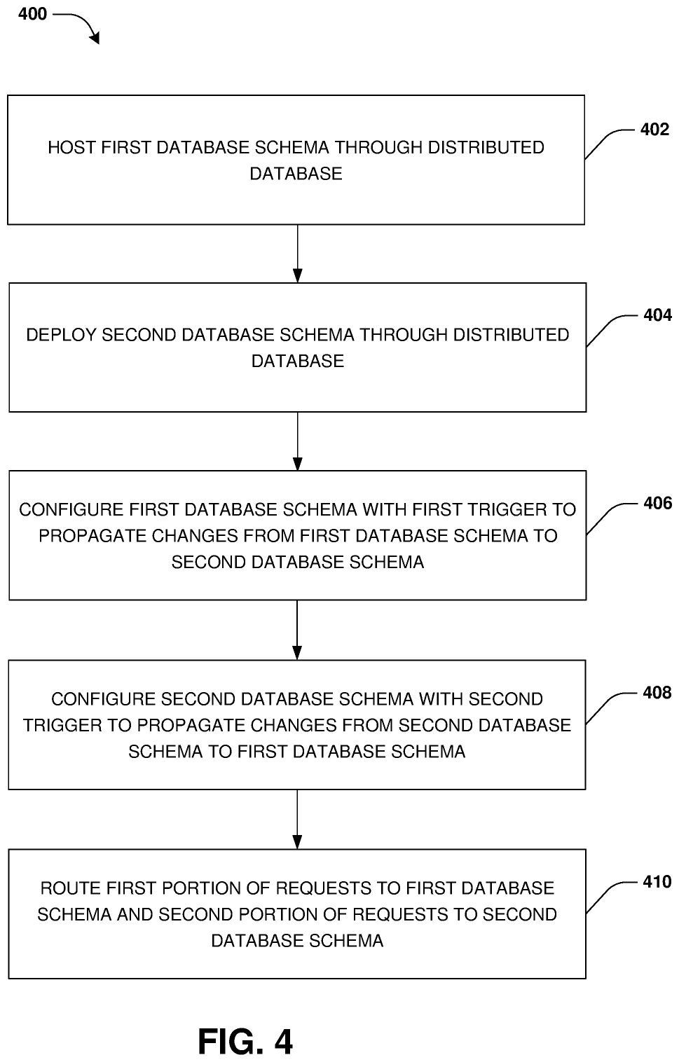

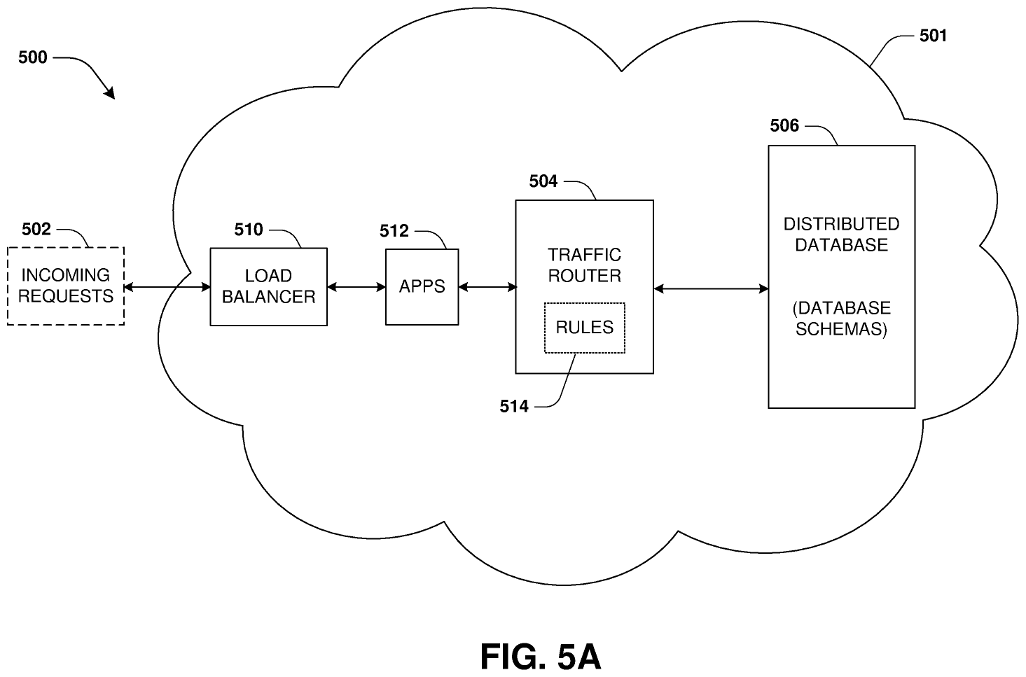

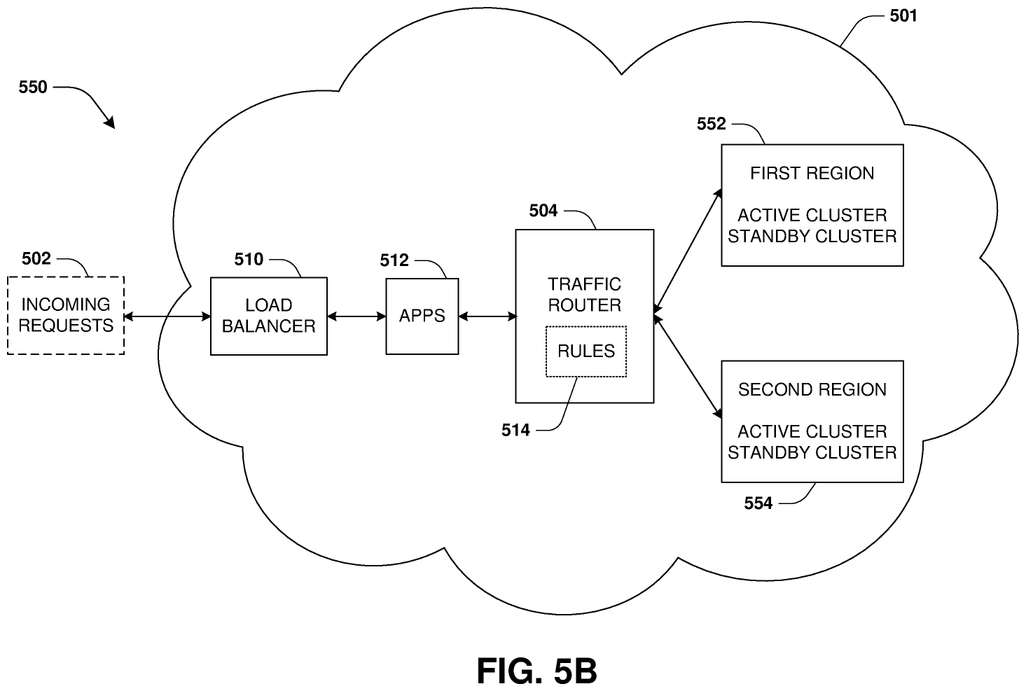

FIG. 4 is a flow chart illustrating an example method 400 for providing near zero downtime during database upgrades for a computing environment, which is described in conjunction with system 500 of FIG. 5A. The computing environment 501 such as a cellular network provides user equipment with communication capabilities over the computing environment 501. Applications 512 may be hosted within the computing environment 501 (e.g., hosted on network equipment) or external to the computing environment 501 (e.g., hosted on user equipment; hosted by a third party platform; etc.). The applications 512 may utilize data stored within a distributed database 506 that may be distributed across network equipment and/or regions of the computing environment 501. The applications 512 may perform database operations such as create, read, update, and delete operations. In some embodiments, incoming requests 502 from clients may be routed by a load balancer 510 of the computing environment 501 to the applications 512. The computing environment 501 includes a traffic router 504 that routes database operations to the distributed database 506 (e.g., incoming client requests for data stored by the applications 512 within the distributed database 506). It may be appreciated that the computing environment 501 may include any number of traffic routers.

A database schema within the distributed database used by the applications may need to be upgraded. For example, the schema may need to have columns and/or tables added to accommodate new data collection, or the semantics and/or format of a data column may need to be changed. These upgrades will be performed to create a second version of the database schema.

During operation 402 of method 400, a first database schema is hosted through the distributed database 506 that may be distributed across multiple regions of the computing environment 501. The first database schema may correspond to a first version of the distributed database 506 that is utilized by an application for operation. As part of upgrading the first version of the distributed database 506 to a second version, a second database schema may be deployed through the distributed database 506, during operation 404 of method 400. The second database schema may correspond to the second version of the distributed database 506 used by the application for operation. In some embodiments, multiple instances of the first database schema and/or multiple instances of the second database schema may be hosted within the computing environment 501 such as within different regions for redundancy, failover, and/or disaster recovery purposes.

During operation 406 of method 400, the first database schema is configured with a first trigger (or any number of triggers). The first trigger comprises a condition that when met, causes the first trigger to propagate data changes/modifications from the first database schema to the second schema. The condition may relate to the application performing a create, update, or delete database operation upon the first database schema, which is then propagated by the first trigger to the second schema (and to any other duplicate instances of the second database schema and/or any other duplicated instances of the first database schema) in order to synchronize the data stored by first and second database schemas. The trigger may be configured to handle the changes made to create the second database schema. For example, the trigger may avoid updating columns/tables that have been dropped, map columns/tables from the first schema to different columns/tables in the second schema, perform data transformation on data for columns that have had their semantics or format changed, etc.

During operation 408 of method 400, the second database schema is configured with a second trigger (or any number of triggers). The second trigger comprises a condition that when met, causes the second trigger to propagate data changes/modifications from the second database schema to the first database schema. The condition may relate to the applications 512 performing a create, update, or delete database operation within the second database schema, which is then propagated by the second trigger to the first database schema (and to any other duplicate instances of the first database schema and/or any other duplicated instances of the second database schema) in order to synchronize the first and second database schemas. For example, the trigger may avoid updating columns/tables that have been dropped, map columns/tables from the second schema to different columns/tables in the first schema, perform data transformation on data for columns that have had their semantics or format changed, etc.

During operation 410 of method 400, the traffic router 504 utilizes progressive rollout rules 514 to determine how to route the database operations amongst the first database schema and the second database schema, as illustrated by FIG. 5A. Based upon the progressive rollout rules 514, the traffic router 504 routes a first portion of the database operations to the first database schema corresponding to the first version of the distributed database 506 used by the application. The traffic router 504 routes a second portion of the database operations to the second database schema corresponding to the second version of the distributed database 506 used by the application. The progressive routing rules 514 may be similar to the routing rules 314 described above with respect to database instances.

Similarly as described above, the processing of the database operations by the second database schema may be monitored (e.g., by the traffic router 504; an artificial intelligence monitoring tool; or other network equipment or component of the computing environment 501) to track whether the database operations are being successfully or unsuccessfully processed. In response to detecting successful operation of the second database schema (e.g., a threshold number or percentage of database operations are successfully processed through the second database schema such as over a particular timespan), the progressive rollout rules 514 are used to adjust the portions of the database operations that are routed to the first database schema and the second database schema to increase the usage of the second database schema. In this way, the percentage/portion of the database operations directed to the second database schema is incrementally increased over time, while the percentage/portion of the database operations directed to the first database schema is incrementally decreased over time based upon successful operation of the second database instance.

The monitoring may detect that the second database schema has been successfully operating over a particular timespan (e.g., successfully processing 90% of all database operations received by the traffic router 504). Accordingly, the first database schema may be removed and the traffic router 504 may route all of the database operations to the second database schema to complete the upgrade.

If a failure or issue is detected with respect to the second database schema during the upgrade (e.g., a threshold percentage of database operations being unsuccessfully processed through the second database schema), then none or a reduced portion of the database operations may be routed to the second database schema. A remedial action may be performed to address the failure or issue such as where the second database schema is modified or redeployed. After the remedial action is successfully performed, the second database schema is resumed and/or database operations are routed to the second database schema.

FIG. 5B illustrates a system 550 where multiple instances of a first version of a database (or a first database schema) and multiple instances of a second version of the database (or a second database schema) are hosted within clusters of different regions of a computing environment 501. A first database instance of the first version of the database may be hosted within an active cluster within a first region 552 of the computing environment 501 for actively processing database operations from clients. A duplicate database instance of the first version of the database may be hosted within a standby cluster within a second region 554 of the computing environment 501 so that the income requests 502 can be redirected by the traffic router 504 to the duplicate database instance in the event the first database instance fails (e.g., a failure of a computing device/node of the active cluster within the first region 552 hosting the first database instance).

As part of upgrading from the first version of the database to the second version of the database, a second database instance of the second version of the database may be hosted within an active cluster within the second region 554 of the computing environment 501 for actively processing database operations from the applications 512. A duplicate database instance of the second version of the database may be hosted within a standby cluster within the first region 552 of the computing environment 501 so that the database operations can be redirected by the traffic router 504 to the duplicate database instance in the event the second database instance fails (e.g., a failure of a computing device/node of the active cluster within the second region 554 hosting the second database instance). In this way, failover and/or disaster recovery can be provided while the database is upgraded from the first version to the second version.

According to some embodiments, a method comprises hosting a first database instance of a first version of a database within a computing environment, wherein at least one application utilizes the database for operation; deploying a second database instance of a second version of the database within a computing environment; configuring the first database instance with a first trigger for propagating data changes from the first database instance to the second database instance; configuring the second database instance with a second trigger for propagating data changes from the second database instance to the first database instance; routing a first portion of requests associated with the at least one application to the first database instance and a second portion of the requests to the second database instance based on a first routing rule of a plurality of routing rules; and monitoring operation of the second database instance to determine whether to progress to a second routing rule of the plurality of routing rules, where the second routing rule increases the second portion of the requests to the second database instance from the first routing rule.

According to some embodiments the monitoring operation of the second database instance includes detecting a failure associated with the second database instance, stopping routing based on the first routing rule in response to detecting the failure, and redirecting the second portion of the requests from the second database instance to the first database instance in response to detecting the failure.

According to some embodiments, the method further comprises executing a remedial action to recover from the failure; and in response to detecting the completion of the remedial action, restarting routing based on the first routing rule.

According to some embodiments, the remedial action comprises at least one of: sending a notification to an administrative platform, the notification including information related to the failure; and sending a request to redeploy the second database instance.

According to some embodiments, the monitoring operation of the second database instance includes: monitoring at least one of request results metrics, database performance metrics and platform performance metrics; and applying at least one monitoring rule to determine whether the second database instance is operating successfully.

According to some embodiments, the method further comprises detecting successful operation of the second database instance; and progressing to the second routing rule in response to detecting the successful operation of the second database instance.

According to some embodiments, the method further comprises monitoring operation of the second database instance to determine whether to progress to a third routing rule of the plurality of rules, where the third routing rule increases the second portion of the requests to the second database instance from the second routing rule.

According to some embodiments, the plurality of routing rules are based on at least one of: a percentage of the requests; a user associated the requests; a region associated with the requests; a performance level for the requests; a date/time window for the requests.

According to some embodiments, the computing environment includes a first region and a second region; the first database instance of the first version of the database is deployed within the first region; the second database instance of the second version of the database is deployed within the second region; deploying a first duplicate instance of the first version of the database within the second region; and deploying a second duplicate instance of the second version of the database within the first region.

According to some embodiments, the method further comprises in response to detecting a failure within the first region, re-routing requests to the first instance of the first version of the database and the second duplicate instance of the second version of the database to the first duplicate instance of the first version of the database and the second database instance of the second version of the database.

According to some embodiments, monitoring operation of the second database instance includes utilizing an artificial intelligence monitoring tool to detect deviations from expected performance.

According to some embodiments, a system comprises one or more processors configured for executing instructions to perform operations comprising: hosting a first database schema within a distributed database that is distributed across multiple regions of a computing environment, wherein the first database schema corresponds to a first version of the distributed database utilized by an application; deploying a second database schema within the distributed database, wherein the second database schema corresponds to a second version of the distributed database utilized by the application; configuring the first database schema with a first trigger for propagating data changes from the first database schema to the second database schema; configuring the second database schema with a second trigger for propagating data changes from the second database schema to the first database schema; routing a first portion of requests associated with the application to the first database schema and a second portion of the requests to the second database schema based on at least one routing rule of a plurality of routing rules; and monitoring operation of the second database schema to determine whether to progress to a second routing rule of the plurality of routing rules, where the second routing rule increases the second portion of the requests to the second database schema from the first routing rule.

According to some embodiments, monitoring operation of the second database schema includes detecting a failure associated with the second database schema, stopping routing based on the first routing rule in response to detecting the failure, and redirecting the second portion of the requests from the second database schema to the first database schema in response to detecting the failure.

According to some embodiments, the operations further comprise: executing a remedial action to recover from the failure, wherein the remedial action includes at least one of sending a notification to an administrative platform, the notification including information related to the failure, or sending a request to redeploy the second database instance; and in response to detecting the completion of the remedial action, restarting routing based on the first routing rule.

According to some embodiments, monitoring operation of the second database schema includes: monitoring at least one of request results metrics, database performance metrics and platform performance metrics; and applying at least one monitoring rule to determine whether the second database schema is operating successfully.

According to some embodiments, the operations further comprise: detecting successful operation of the second database schema; and progressing to the second routing rule in response to detecting the successful operation of the second database schema.

According to some embodiments, the operations further comprise: monitoring operation of the second database schema to determine whether to progress to a third routing rule of the plurality of rules, where the third routing rule increases the second portion of the requests to the second database schema from the second routing rule.

According to some embodiments, the plurality of routing rules are based on at least one of: a percentage of the requests; a user associated the requests; a region associated with the requests; a performance level for the requests; a date/time window for the requests.

According to some embodiments, a method, comprises: providing a plurality of routing rules for a database having a first version and a second version, the plurality of routing rules including a first routing rule and a second routing rule, wherein the first routing rule specifies a first portion of received database requests to route to a second version of the database, and the second routing rule specifies a second portion of received database requests to route to the second version of the database interface connection, and wherein the second portion is larger than the first portion; routing received database requests according to the first routing rule; monitoring operation of the second version of database to determine whether the second version of the database is operating successfully during routing using the first routing rule; and routing received database requests according to the second routing rule when it is determined that the second version of the database is operating successfully.

According to some embodiments, the plurality of routing rules includes a third routing rule that specifies a third portion of received database requests to route to the second version of the database, the third portion being larger than the second portion, and the method further comprises: monitoring operation of the second version of database to determine whether the second version of the database is operating successfully during routing using the second routing rule; and routing received database requests according to the third routing rule when it is determined that the second version of the database is operating successfully during routing using the second routing

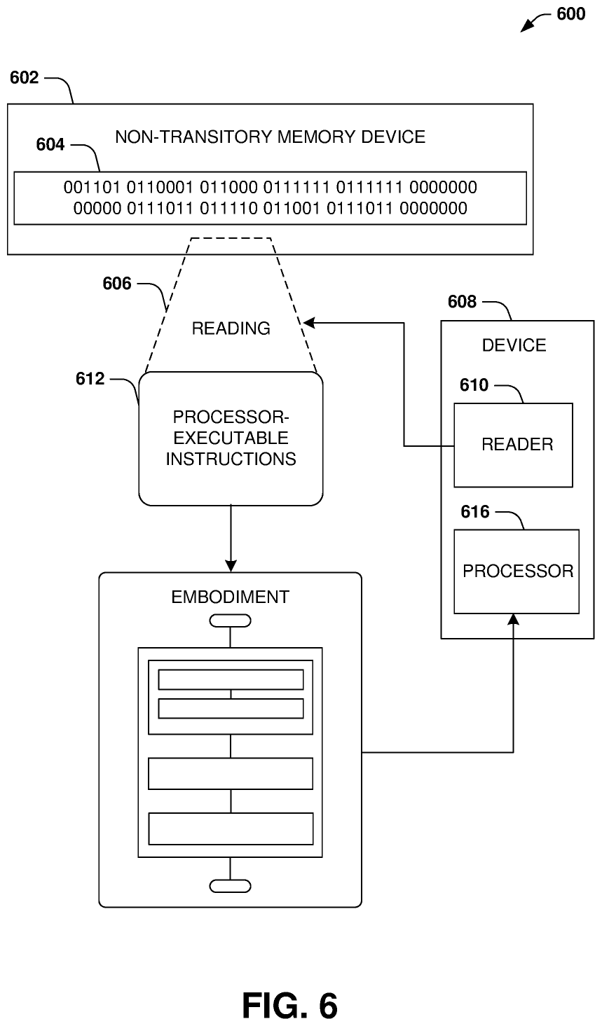

FIG. 6 is an illustration of a scenario 600 involving an example non-transitory machine readable medium 602. The non-transitory machine readable medium 602 may comprise processor-executable instructions 612 that when executed by a processor 616 cause performance (e.g., by the processor 616) of at least some of the provisions herein. The non-transitory machine readable medium 602 may comprise a memory semiconductor (e.g., a semiconductor utilizing static random access memory (SRAM), dynamic random access memory (DRAM), and/or synchronous dynamic random access memory (SDRAM) technologies), a platter of a hard disk drive, a flash memory device, or a magnetic or optical disc (such as a compact disk (CD), a digital versatile disk (DVD), or floppy disk). The example non-transitory machine readable medium 602 stores computer-readable data 604 that, when subjected to reading 606 by a reader 610 of a device 608 (e.g., a read head of a hard disk drive, or a read operation invoked on a solid-state storage device), express the processor-executable instructions 612. In some embodiments, the processor-executable instructions 612, when executed cause performance of operations, such as at least some of the example method 200 of FIG. 2 and/or at least some of the example method 400 of FIG. 4, for example. In some embodiments, the processor-executable instructions 612 are configured to cause implementation of a system, such as at least some of the example system 100 of FIG. 1, at least some of the example system 300 of FIGS. 3A-3E, at least some of the example system 500 of FIG. 5A, and/or at least some of the example system 550 of FIG. 5B.

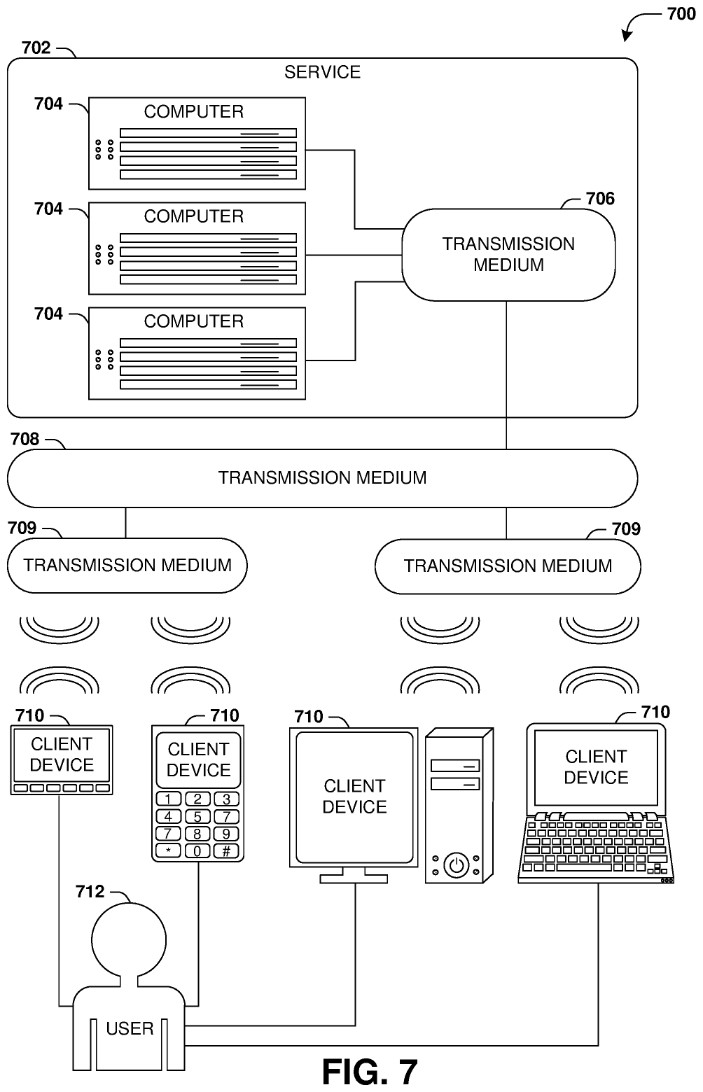

FIG. 7 is an interaction diagram of a scenario 700 illustrating a service 702 provided by a set of computers 704 to a set of client devices 710 via various types of transmission mediums. The computers 704 and/or client devices 710 may be capable of transmitting, receiving, processing, and/or storing many types of signals, such as in memory as physical memory states.

In some embodiments, the computers 704 may be host devices and/or the client device 710 may be devices attempting to communicate with the computer 704 over buses for which device authentication for bus communication is implemented.

The computers 704 of the service 702 may be communicatively coupled together, such as for exchange of communications using a transmission medium 706. The transmission medium 706 may be organized according to one or more network architectures, such as computer/client, peer-to-peer, and/or mesh architectures, and/or a variety of roles, such as administrative computers, authentication computers, security monitor computers, data stores for objects such as files and databases, business logic computers, time synchronization computers, and/or front-end computers providing a user-facing interface for the service 702.

Likewise, the transmission medium 706 may comprise one or more sub-networks, such as may employ different architectures, may be compliant or compatible with differing protocols and/or may interoperate within the transmission medium 706. Additionally, various types of transmission medium 706 may be interconnected (e.g., a router may provide a link between otherwise separate and independent transmission medium 706).

In scenario 700 of FIG. 7, the transmission medium 706 of the service 702 is connected to a transmission medium 708 that allows the service 702 to exchange data with other services 702 and/or client devices 710. The transmission medium 708 may encompass various combinations of devices with varying levels of distribution and exposure, such as a public wide-area network and/or a private network (e.g., a virtual private network (VPN) of a distributed enterprise).

In the scenario 700 of FIG. 7, the service 702 may be accessed via the transmission medium 708 by a user 712 of one or more client devices 710, such as a portable media player (e.g., an electronic text reader, an audio device, or a portable gaming, exercise, or navigation device); a portable communication device (e.g., a camera, a phone, a wearable or a text chatting device); a workstation; and/or a laptop form factor computer. The respective client devices 710 may communicate with the service 702 via various communicative couplings to the transmission medium 708. As a first such example, one or more client devices 710 may comprise a cellular communicator and may communicate with the service 702 by connecting to the transmission medium 708 via a transmission medium 709 provided by a cellular provider. As a second such example, one or more client devices 710 may communicate with the service 702 by connecting to the transmission medium 708 via a transmission medium 709 provided by a location such as the user's home or workplace (e.g., a Wi-Fi (Institute of Electrical and Electronics Engineers (IEEE) Standard 802.11) network or a Bluetooth (IEEE Standard 802.15.1) personal area network). In this manner, the computers 704 and the client devices 710 may communicate over various types of transmission mediums.

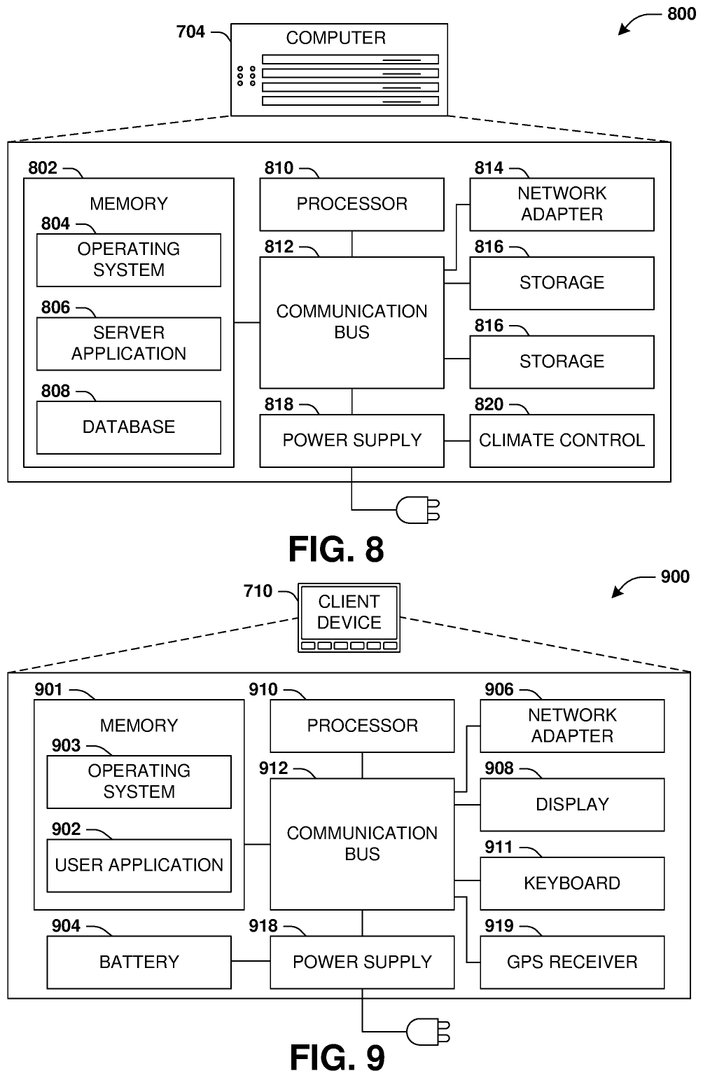

FIG. 8 presents a schematic architecture diagram 800 of a computer 804 that may utilize at least a portion of the techniques provided herein. Such a computer 804 may vary widely in configuration or capabilities, alone or in conjunction with other computers, in order to provide a service.

The computer 804 may comprise one or more processors 810 that process instructions. The one or more processors 810 may optionally include a plurality of cores; one or more coprocessors, such as a mathematics coprocessor or an integrated graphical processing unit (GPU); and/or one or more layers of local cache memory. The computer 804 may comprise memory 802 storing various forms of applications, such as an operating system 804; one or more computer applications 806; and/or various forms of data, such as a database 808 or a file system. The computer 804 may comprise a variety of peripheral components, such as a wired and/or wireless network adapter 814 connectible to a local area network and/or wide area network; one or more storage components 816, such as a hard disk drive, a solid-state storage device (SSD), a flash memory device, and/or a magnetic and/or optical disk reader.

The computer 804 may comprise a mainboard featuring one or more communication buses 812 that interconnect the processor 810, the memory 802, and various peripherals, using a variety of bus technologies, such as a variant of a serial or parallel AT Attachment (ATA) bus protocol; a Uniform Serial Bus (USB) protocol; and/or Small Computer System Interface (SCI) bus protocol. In a multibus scenario, a communication bus 812 may interconnect the computer 804 with at least one other computer. Other components that may optionally be included with the computer 804 (though not shown in the schematic architecture diagram 800 of FIG. 8) include a display; a display adapter, such as a graphical processing unit (GPU); input peripherals, such as a keyboard and/or mouse; and a flash memory device that may store a basic input/output system (BIOS) routine that facilitates booting the computer 804 to a state of readiness.

The computer 804 may operate in various physical enclosures, such as a desktop or tower, and/or may be integrated with a display as an “all-in-one” device. The computer 804 may be mounted horizontally and/or in a cabinet or rack, and/or may simply comprise an interconnected set of components. The computer 804 may comprise a dedicated and/or shared power supply 818 that supplies and/or regulates power for the other components. The computer 804 may provide power to and/or receive power from another computer and/or other devices. The computer 804 may comprise a shared and/or dedicated climate control unit 820 that regulates climate properties, such as temperature, humidity, and/or airflow. Many such computers 804 may be configured and/or adapted to utilize at least a portion of the techniques presented herein.

FIG. 9 presents a schematic architecture diagram 900 of a client device 710 whereupon at least a portion of the techniques presented herein may be implemented. Such a client device 710 may vary widely in configuration or capabilities, in order to provide a variety of functionality to a user such as the user 712. The client device 710 may be provided in a variety of form factors, such as a desktop or tower workstation; an “all-in-one” device integrated with a display 908; a laptop, tablet, convertible tablet, or palmtop device; a wearable device mountable in a headset, eyeglass, earpiece, and/or wristwatch, and/or integrated with an article of clothing; and/or a component of a piece of furniture, such as a tabletop, and/or of another device, such as a vehicle or residence. The client device 710 may serve the user in a variety of roles, such as a workstation, kiosk, media player, gaming device, and/or appliance.

The client device 710 may comprise one or more processors 910 that process instructions. The one or more processors 910 may optionally include a plurality of cores; one or more coprocessors, such as a mathematics coprocessor or an integrated graphical processing unit (GPU); and/or one or more layers of local cache memory. The client device 710 may comprise memory 901 storing various forms of applications, such as an operating system 903; one or more user applications 902, such as document applications, media applications, file and/or data access applications, communication applications such as web browsers and/or email clients, utilities, and/or games; and/or drivers for various peripherals. The client device 710 may comprise a variety of peripheral components, such as a wired and/or wireless network adapter 906 connectible to a local area network and/or wide area network; one or more output components, such as a display 908 coupled with a display adapter (optionally including a graphical processing unit (GPU)), a sound adapter coupled with a speaker, and/or a printer; input devices for receiving input from the user, such as a keyboard 911, a mouse, a microphone, a camera, and/or a touch-sensitive component of the display 908; and/or environmental sensors, such as a global positioning system (GPS) receiver 919 that detects the location, velocity, and/or acceleration of the client device 710, a compass, accelerometer, and/or gyroscope that detects a physical orientation of the client device 710. Other components that may optionally be included with the client device 710 (though not shown in the schematic architecture diagram 900 of FIG. 9) include one or more storage components, such as a hard disk drive, a solid-state storage device (SSD), a flash memory device, and/or a magnetic and/or optical disk reader; and/or a flash memory device that may store a basic input/output system (BIOS) routine that facilitates booting the client device 710 to a state of readiness; and a climate control unit that regulates climate properties, such as temperature, humidity, and airflow.

The client device 710 may comprise a mainboard featuring one or more communication buses 912 that interconnect the processor 910, the memory 901, and various peripherals, using a variety of bus technologies, such as a variant of a serial or parallel AT Attachment (ATA) bus protocol; the Uniform Serial Bus (USB) protocol; and/or the Small Computer System Interface (SCI) bus protocol. The client device 710 may comprise a dedicated and/or shared power supply 918 that supplies and/or regulates power for other components, and/or a battery 904 that stores power for use while the client device 710 is not connected to a power source via the power supply 918. The client device 710 may provide power to and/or receive power from other client devices.

As used in this application, “component,” “module,” “system”, “interface”, and/or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Unless specified otherwise, “first,” “second,” and/or the like are not intended to imply a temporal aspect, a spatial aspect, an ordering, etc. Rather, such terms are merely used as identifiers, names, etc. for features, elements, items, etc. For example, a first object and a second object generally correspond to object A and object B or two different or two identical objects or the same object.

Moreover, “example” is used herein to mean serving as an example, instance, illustration, etc., and not necessarily as advantageous. As used herein, “or” is intended to mean an inclusive “or” rather than an exclusive “or”. In addition, “a” and “an” as used in this application are generally be construed to mean “one or more” unless specified otherwise or clear from context to be directed to a singular form. Also, at least one of A and B and/or the like generally means A or B or both A and B. Furthermore, to the extent that “includes”, “having”, “has”, “with”, and/or variants thereof are used in either the detailed description or the claims, such terms are intended to be inclusive in a manner similar to the term “comprising”.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing at least some of the claims.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, many modifications may be made to this configuration without departing from the scope or spirit of the claimed subject matter.

Various operations of embodiments are provided herein. In an embodiment, one or more of the operations described may constitute computer readable instructions stored on one or more computer readable media, which if executed by a computing device, will cause the computing device to perform the operations described. The order in which some or all of the operations are described should not be construed as to imply that these operations are necessarily order dependent. Alternative ordering may be implemented without departing from the scope of the disclosure. Further, it will be understood that not all operations are necessarily present in each embodiment provided herein. Also, it will be understood that not all operations are necessary in some embodiments.

Also, although the disclosure has been shown and described with respect to one or more implementations, alterations and modifications may be made thereto and additional embodiments may be implemented based upon a reading and understanding of this specification and the annexed drawings. The disclosure includes all such modifications, alterations and additional embodiments and is limited only by the scope of the following claims. The specification and drawings are accordingly to be regarded in an illustrative rather than restrictive sense. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure. In addition, while a particular feature of the disclosure may have been disclosed with respect to only one of several implementations, such feature may be combined with one or more other features of the other implementations as may be desired and advantageous for any given or particular application.

In the preceding specification, various example embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense. To the extent the aforementioned implementations collect, store, or employ personal information of individuals, groups or other entities, it should be understood that such information shall be used in accordance with all applicable laws concerning protection of personal information. Additionally, the collection, storage, and use of such information can be subject to consent of the individual to such activity, for example, through well known “opt-in” or “opt-out” processes as can be appropriate for the situation and type of information. Storage and use of personal information can be in an appropriately secure manner reflective of the type of information, for example, through various access control, encryption and anonymization techniques for particularly sensitive information.

What is claimed:

1. A method, comprising:
hosting a first database instance of a first version of a database within a computing environment, wherein at least one application utilizes the database for operation;
deploying a second database instance of a second version of the database within a computing environment;
configuring the first database instance with a first trigger for propagating data changes from the first database instance to the second database instance;
configuring the second database instance with a second trigger for propagating data changes from the second database instance to the first database instance;
routing a first portion of requests associated with the at least one application to the first database instance and a second portion of the requests to the second database instance based on a first routing rule of a plurality of routing rules; and
monitoring operation of the second database instance to determine whether to progress to a second routing rule of the plurality of routing rules, where the second routing rule increases the second portion of the requests to the second database instance from the first routing rule.

2. The method of claim 1, wherein monitoring operation of the second database instance includes detecting a failure associated with the second database instance, stopping routing based on the first routing rule in response to detecting the failure, and redirecting the second portion of the requests from the second database instance to the first database instance in response to detecting the failure.

3. The method of claim 2, further comprising:
executing a remedial action to recover from the failure; and
in response to detecting the completion of the remedial action, restarting routing based on the first routing rule.

4. The method of claim 3, wherein the remedial action comprises at least one of:
sending a notification to an administrative platform, the notification including information related to the failure;
sending a request to redeploy the second database instance.

5. The method of claim 1, wherein monitoring operation of the second database instance includes:
monitoring at least one of request results metrics, database performance metrics and platform performance metrics; and
applying at least one monitoring rule to determine whether the second database instance is operating successfully.

6. The method of claim 1, comprising:
detecting successful operation of the second database instance; and
progressing to the second routing rule in response to detecting the successful operation of the second database instance.

7. The method of claim 1, comprising:
monitoring operation of the second database instance to determine whether to progress to a third routing rule of the plurality of rules, where the third routing rule increases the second portion of the requests to the second database instance from the second routing rule.

8. The method of claim 1, wherein the plurality of routing rules are based on at least one of:
a percentage of the requests;
a user associated the requests;
a region associated with the requests;
a performance level for the requests; or
a date/time window for the requests.

9. The method of claim 1, wherein:
the computing environment includes a first region and a second region;
the first database instance of the first version of the database is deployed within the first region;
the second database instance of the second version of the database is deployed within the second region;
deploying a first duplicate instance of the first version of the database within the second region; and
deploying a second duplicate instance of the second version of the database within the first region.

10. The method of claim 9, comprising:
in response to detecting a failure within the first region, re-routing requests to the first instance of the first version of the database and the second duplicate instance of the second version of the database to the first duplicate instance of the first version of the database and the second database instance of the second version of the database.

11. The method of claim 1, wherein monitoring operation of the second database instance includes utilizing an artificial intelligence monitoring tool to detect deviations from expected performance.

12. A system, comprising:
one or more processors configured for executing instructions to perform operations comprising:
hosting a first database schema within a distributed database that is distributed across multiple regions of a computing environment, wherein the first database schema corresponds to a first version of the distributed database utilized by an application;
deploying a second database schema within the distributed database, wherein the second database schema corresponds to a second version of the distributed database utilized by the application;
configuring the first database schema with a first trigger for propagating data changes from the first database schema to the second database schema;
configuring the second database schema with a second trigger for propagating data changes from the second database schema to the first database schema;
routing a first portion of requests associated with the application to the first database schema and a second portion of the requests to the second database schema based on at least one routing rule of a plurality of routing rules; and
monitoring operation of the second database schema to determine whether to progress to a second routing rule of the plurality of routing rules, where the second routing rule increases the second portion of the requests to the second database schema from the first routing rule.

13. The system of claim 12, wherein the operations further comprise:
wherein monitoring operation of the second database schema includes detecting a failure associated with the second database schema, stopping routing based on the first routing rule in response to detecting the failure, and redirecting the second portion of the requests from the second database schema to the first database schema in response to detecting the failure.

14. The system of claim 13, wherein the operations further comprise:
executing a remedial action to recover from the failure, wherein the remedial action includes at least one of
sending a notification to an administrative platform, the notification including information related to the failure, or
sending a request to redeploy the second database instance; and
in response to detecting the completion of the remedial action, restarting routing based on the first routing rule.

15. The system of claim 12, wherein monitoring operation of the second database schema includes:
monitoring at least one of request results metrics, database performance metrics and platform performance metrics; and
applying at least one monitoring rule to determine whether the second database schema is operating successfully.

16. The system of claim 12, wherein the operations further comprise:
detecting successful operation of the second database schema; and
progressing to the second routing rule in response to detecting the successful operation of the second database schema.

17. The system of claim 12, wherein the operations further comprise:
monitoring operation of the second database schema to determine whether to progress to a third routing rule of the plurality of rules, where the third routing rule increases the second portion of the requests to the second database schema from the second routing rule.

18. The system of claim 12, wherein the plurality of routing rules are based on at least one of:
a percentage of the requests;
a user associated the requests;
a region associated with the requests;
a performance level for the requests; or
a date/time window for the requests.

19. A method, comprising:
providing a plurality of routing rules for a database having a first version and a second version, the plurality of routing rules including a first routing rule and a second routing rule, wherein the first routing rule specifies a first portion of received database requests to route to a second version of the database, and the second routing rule specifies a second portion of received database requests to route to the second version of the database interface connection, and wherein the second portion is larger than the first portion;
routing received database requests according to the first routing rule;
monitoring operation of the second version of database to determine whether the second version of the database is operating successfully during routing using the first routing rule; and
routing received database requests according to the second routing rule when it is determined that the second version of the database is operating successfully.

20. The method of claim 19, wherein the plurality of routing rules includes a third routing rule that specifies a third portion of received database requests to route to the second version of the database, the third portion being larger than the second portion, and further comprising:
monitoring operation of the second version of database to determine whether the second version of the database is operating successfully during routing using the second routing rule; and
routing received database requests according to the third routing rule when it is determined that the second version of the database is operating successfully during routing using the second routing rule.
